(19) United States
(12) Patent Application Publication
(10) Pub. No.: US 2015/0234372 A1
(43) Pub. Date: Aug. 20, 2015

(54) Appliance capable of advertising needs and responding to needs of other appliances and systems

(71) Applicant: Seed Labs Sp. z o.o., Krakow (PL)

(72) Inventors: Szymon Slupik, Krakow (PL); Adam Gembala, Krakow (PL)

(21) Appl. No.: 14/624,491

(22) Filed: Feb. 17, 2015

Related U.S. Application Data
(60) Provisional application No. 61/941,006, filed on Feb. 18, 2014.

(51) Int. Cl. G05B 15/02; H04L 12/28

(52) U.S. Cl. CPC G05B 15/02; H04L 12/2803

(57) ABSTRACT

A home automation and control system that enables the coordinated performance of household functions by appliances and of shopping for consumables, including shopping for fast-moving consumer goods (FMCG) and other consumables that are needed and used by appliances and their consumer users. The disclosed system comprises one or more networked “smart” appliances and a controlling device such as a smartphone that executes an application configured to interact with the smart appliances. In accordance with the illustrative embodiment of the present invention, at least some of the smart appliances are configured to sense various needs as they arise and to broadcast those needs to the system at large. In addition, at least some of the smart appliances are configured to fulfill those needs advertised by the other appliances within the system and to perform household functions.

### CROSS REFERENCE TO RELATED APPLICATIONS

The following case is incorporated herein by reference:

(1) U.S. Patent Application Ser. No. 61/941,006, filed Feb. 18, 2014.

If there are any contradictions or inconsistencies in language between this application and the case that has been incorporated by reference that might affect the interpretation of the claims in this application, the claims in this application should be interpreted to be consistent with the language in this application.

### FIELD OF THE INVENTION

The present invention relates to building automation and control in general, and, more particularly, to a networked appliance that is capable of advertising needs and responding to the needs of other appliances and systems.

### BACKGROUND OF THE INVENTION

Home automation refers to the use of computer and information technology to control home systems such as lighting, HVAC, audio-visual, smoke detection, security, and shading, among others. Using specialized hardware, even household appliances can be monitored and controlled automatically. A feature of science fiction for many years, home automation has only recently become practical, both from a technological and cost perspective. This is due in part to the rapid advancement of information technology.

A sophisticated home automation system may include sensor-equipped devices to measure physical conditions (e.g., of temperature, of light, of motion, etc.) and actuator-equipped devices to perform work (e.g., using motorized valves, using heat sources, etc.). The system may also include a human-machine interface device that enables a resident of the home to interact with the system. The interface can be a specialized terminal or an application (“app”) running on a smart phone or tablet computer. The various system devices communicate over dedicated wiring, or over a wired network, or wirelessly, using one or more protocols.

A smart appliance is a sensor-equipped and/or actuator-equipped device in a home, or other setting, that often performs a conventional function, such as cooking or cleaning, but with connectivity to at least one other device, such as another appliance. Smart appliances can gain enhanced capabilities through their ability to interact, with each other and with other devices.

### SUMMARY OF THE INVENTION

A home automation and control system is disclosed that enables the coordinated performance of household functions by appliances and of shopping for consumables, including shopping for fast-moving consumer goods (FMCG) and other consumables that are needed and used by appliances and their consumer users. The disclosed system comprises one or more networked “smart” appliances and a controlling device such as a smartphone that executes an application configured to interact with the smart appliances. In accordance with the illustrative embodiment of the present invention, at least some of the smart appliances are configured to sense various needs as they arise and to broadcast those needs to the system at large. In addition, at least some of the smart appliances are configured to fulfill those needs advertised by the other appliances within the system. At least some of the aforementioned appliances are configured to perform household functions.

Various examples of smart appliances are provided in this specification for pedagogical purposes, such as a smart kettle. Two or more appliances, such as the smart kettle and another appliance, can wirelessly coordinate activities provided that i) at least one of the appliances is able to advertise a need, such as the need for a descaling kit and ii) one or more of the other appliances is able to listen to needs being advertised. For instance, when a user happens to have a smart kettle and a smart dishwasher that use the same descaling kit, these appliances can advertise their respective needs and other information via a Bluetooth Low Energy (BLE) connection, listen to each other, and, as a result, determine whether to order one or more kits with or without the user's intervention. The smart kettle is capable of informing its user, via a smartphone app and a BLE connection, about the need to descale the kettle and of information related to ordering the descaling kit. The smart kettle through the smartphone app can also make recommendations at to what teas and other related consumables to order based in part on prior usage by its user.

Another example of the inventive system involves a different grouping of two or more appliances that are being used with a unified household purpose in mind. For example, a multicooker and a food processor can be networked together for the preparation of a meal, in which they coordinate the kinds of cooking ingredients to recommend or to order, based upon the two appliances advertising information and listening to such advertised information, and as a result knowing that they are being used together. The appliances are able to communicate with the user through the smartphone app and assist the user with purchasing decisions. The app itself is further capable of filtering the recommendations made by the appliances and creating shopping lists, which can then be presented to the user.

In regard to the foregoing example, having this type of coordination amongst the appliances and smartphone app enables a product maker to offer a suite of smart appliances. The consumer user, who has acquired two or more of these appliances, turns them on, thereby enabling them to transmit and receive messages. The appliances advertise their needs and other information (e.g., via BLE, via WiFi, etc.), and also to the information being advertised; as a result, these appliances know more of the context in which they go about ordering supplies, making suggestions or recommendations, and so on. For instance, a multicooker might make one set of recommendations if it does not already know that the consumer also has a food processor. Then, once the multicooker and the food processor advertise their presence to each other—as well as to whichever other appliances are within listening range—the multicooker might make a different set of recommendations because it now knows that the consumer also has access to the food processor, or vice-versa.

The connected appliances disclosed herein are capable of making automatic reorders, providing usage statistics, maintaining and using broad context awareness (e.g., vacation plans of one or more household members, weather forecasts, household-related events, etc.) in fulfilling one or needs, and making service notifications, involving an exchange of information with each other and/or the smartphone app. In addition to having at least some of the foregoing capabilities, the mobile station by executing the smartphone app is capable of generating and managing one or more shopping lists of items that are used by the connected appliances.

As mentioned earlier, at least some of the smart appliance devices are capable of advertising information and at least some of the smart appliance devices are capable of listening to information that is being advertised. A listening device can act based on the knowledge of the transmitted message payload and the sender as identified by its address. Thus, the listening device essentially knows which device is advertising what information. In support of this, the discriminating logic is in each listening device; this creates a loosely-bonded system, in which senders continually and independently broadcast messages and listeners decide whether to act upon them. With this distributed logic being in the listening devices, it is up to each listening device to listen to and collect only specific messages or all messages, and to maintain a message history or not, in the course of acting upon one or more of the received messages. In the system of the illustrative embodiment, which has no centralized controller, having the intelligence in the listening devices makes the system very flexible and scalable.

Smart appliances are featured in the illustrative embodiment of the present invention. As those who are skilled in the art will appreciate after reading this specification, however, a different type of device can be made and used with at least some of the same features in mind. Furthermore, although an advertising device of the illustrative embodiment transmits its own address only, it will be clear to those skilled in the art, after reading this specification, how to make and use embodiments of the present invention in which a transmitting device also specifies a destination address, as in point-to-point communication, or another type of address other than its own.

An illustrative home automation and control system comprises: a first device, wherein the first device is capable of identifying itself with a first address, and is configured to advertise wirelessly the first address and a first need concurrently with each other, wherein the first device is incapable by itself of fulfilling the first need; and a second device, wherein the second device is capable of identifying itself with a second address, and is configured to: i) detect information advertised by devices besides the second device, and ii) respond to detection of the first need as advertised by the first device such that the first need is at least partially fulfilled; wherein the first device is configured to refrain from transmitting, in conjunction with advertising the first need, any address except for the first address; and wherein the second device is configured to refrain from transmitting, in conjunction with responding to the detection of the first need, any address except for the second address.

Another home automation and control system comprises: a first device, wherein the first device is capable of identifying itself with a first address, and is configured to advertise wirelessly the first address and a first need and concurrently with each other, wherein the first device is incapable by itself of fulfilling the first need; a second device, wherein the second device is capable of identifying itself with a second address, and is configured to advertise wirelessly the second address and a second need concurrently with each other, wherein the second device is incapable by itself of fulfilling the second need; and a third device configured to: i) detect information advertised by devices besides the third device, ii) respond to detection of the first need as advertised by the first device without transmitting the first address, and iii) respond to detection of the second need as advertised by the second device without transmitting the second address; wherein the third device responds to the detections of the first and second need by displaying a datum that is based on the relationship of the first and second need to each other.

Still another home automation and control system comprises: a first device, wherein the first device is capable of identifying itself with a first address, and is configured to advertise wirelessly the first address and a first need of a consumable concurrently with each other, wherein the first device is incapable by itself of fulfilling the first need; and a second device, wherein the second device is capable of identifying itself with a second address, and is configured to: i) detect information advertised by devices besides the second device, and ii) respond to detection of the first need as advertised by the first device, based on a) the first need and b) the second device having a second need that is substantially similar to the first need as advertised by the first device; and wherein the first device is configured to refrain from transmitting, in conjunction with advertising the first need, any address except for the first address.

### BRIEF DESCRIPTION OF THE DRAWINGS

FIG. 1 depicts automation system 100, in accordance with the illustrative embodiment of the present invention.

FIG. 2 depicts an illustrative floor plan of building environment 200, within which smart devices operate.

FIG. 3 depicts a zoomed-in view of vicinity 300 around the kitchen area of environment 200.

FIG. 4 depicts the salient components of smart appliance 101-m according to the illustrative embodiment of the present invention.

FIG. 5 depicts the salient components of mobile station 102 according to the illustrative embodiment of the present invention.

FIG. 6 depicts some salient operations of method 600 according to the illustrative embodiment of the present invention, performed by one or more smart appliances 101.

FIG. 7 depicts some salient sub-operations within operation 603 of method 600.

FIG. 8 depicts some salient sub-operations within operation 605 of method 600.

FIG. 9 some salient operations of method 900 according to the illustrative embodiment of the present invention, performed by mobile station 102.

### DETAILED DESCRIPTION

For the purposes of the present specification, the following terms and their inflected forms are defined as follows:
i. An “address” is defined as a set of numbers that uniquely identifies the physical or logical location of a device.
ii. To “advertise” is defined as to make a quality or fact known.
iii. An “appliance” is defined as a device or piece of equipment designed to perform a specific task such as, but without being limited to, a domestic task. A “smart appliance” or “connected appliance” is an appliance that is able to telecommunicate with at least one other device.
iv. To “broadcast” is defined as to send network traffic from one network node to all other network nodes that are within telecommunication range of the sending network node.
v. A “building” is defined as a structure with a roof and walls such as, but without being limited to, a house, a school, a store, a factory, an apartment complex, an office complex, or a corporate office. A building can comprise one or more dwellings such as, but without being limited to, a house, an apartment, or another place of residence.
vi. A “consumable good” or “consumable” is defined as a product that is intended to be used up and replaced recurrently.
vii. A “device” is defined as a thing made or adapted for a particular purpose, especially a piece of mechanical or electronic equipment.
viii. A “household function” is defined as a function that is performed to the benefit and/or need of a house and its occupants.
ix. An “ingredient” is defined as a substance or component of something that is being prepared.
x. A “message” is defined as a discrete unit of communication intended by the source for consumption by some recipient or group of recipients, and is conveyed by one or more electrical impulses or radio waves.
xi. A “need” is defined as a thing that is wanted or required. In regard to what constitutes a need, a need might be, for example and without limitation, a particular object, commodity, or resource; one such object, commodity, or resource versus another; and/or a particular amount of something. More specifically, non-limiting examples of a need are a consumable and an ingredient. In regard to when a need might arise, a need might be, for example and without limitation, continuous, continual, periodic, sporadic, arising more than once, arising more than a set number of times, arising presently, arising in the future, eventual, ongoing, and/or cotemporaneous with something else. Two needs might be substantially similar, in that the same thing or similar things can fulfill them both. A need can be fulfilled directly by acquiring the needed thing, can be fulfilled by notifying a specific entity (i.e., by addressing it directly) that can, in turn, directly fulfill the need, or can be at least addressed. A need is not considered to be fulfilled merely by the action of broadcasting the need to other appliances. A need can derive from a household function being performed.
xii. An “offer” is defined as an expression of readiness to do or give something.
xiii. A “signal” is defined as an electrical impulse or radio wave transmitted or received.

Other terms may also be defined elsewhere herein.

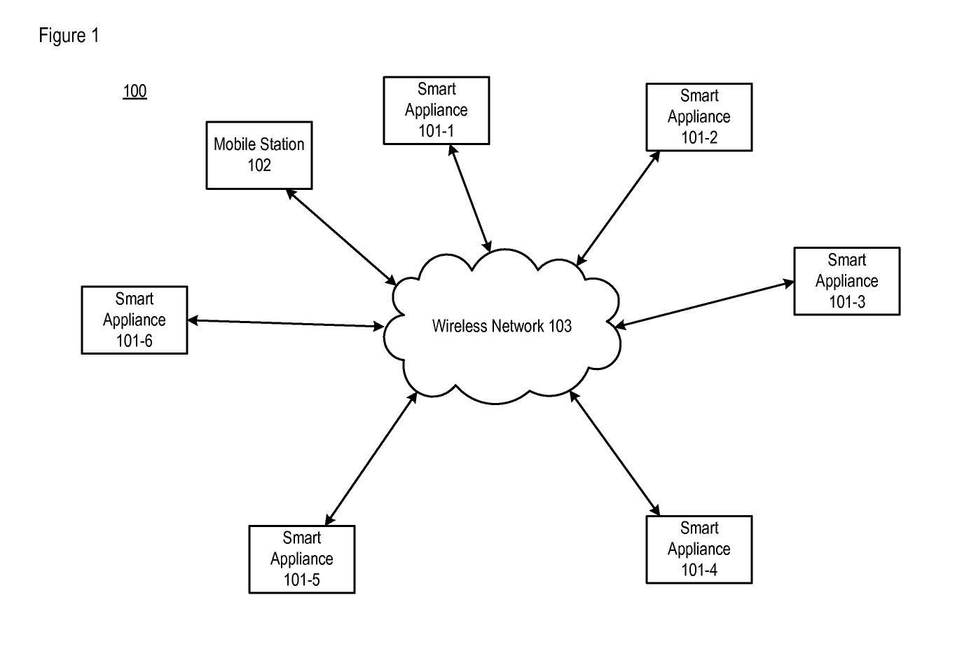

FIG. 1 depicts automation system 100, in accordance with the illustrative embodiment of the present invention. System 100 comprises: smart appliances 101-1 through 101-M, wherein M is a positive integer; mobile station 102 executing a smartphone application (“app”); and wireless network 103. The aforementioned elements are interrelated as shown and, as depicted, are physically distinct devices with respect to one another.

In accordance with the illustrative embodiment of the present invention, automation system 100 is an automation and control system in the home. As those who are skilled in the art will appreciate after reading this specification, however, automation system 100 can be applied to any type of building, including the environment surrounding the building, or to any environment in which automated control can be applied.

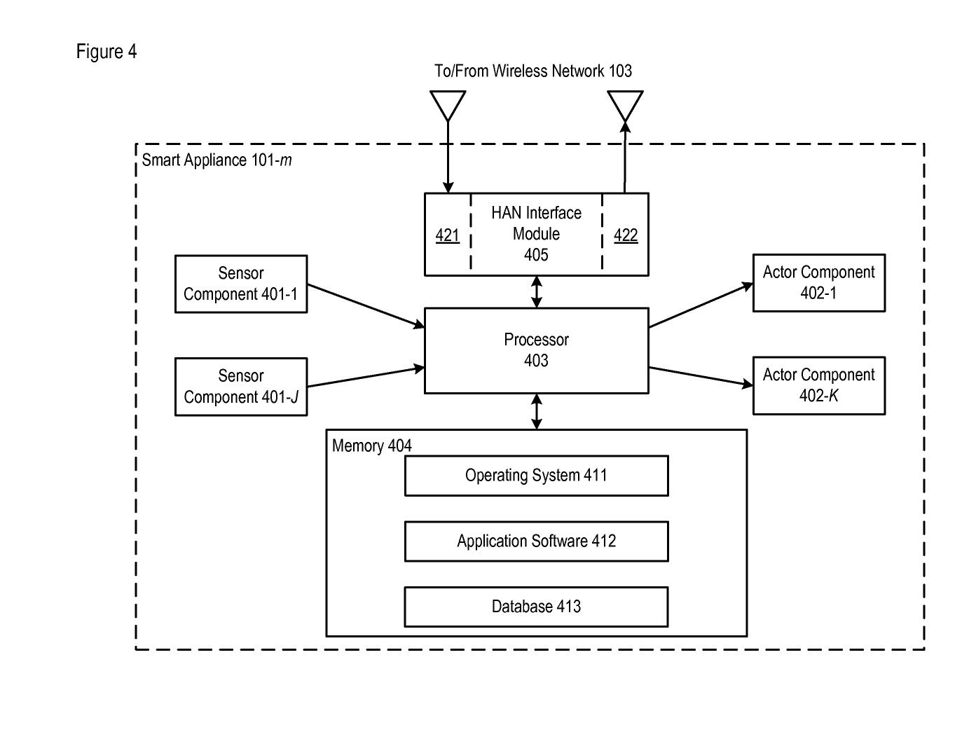

Smart appliance 101-m, wherein m can have a value between 1 and M, inclusive, is an apparatus that comprises memory, processing components, and communication components. For reasons of conciseness, smart appliance 101-m is also referred to as “smart appliance 101” or “appliance 101” in the specification. Appliance 101 performs one or more household functions, as well as other actions, based on i) input signals from a user and/or input signals received from one or more built-in sensors (e.g., switches, temperature sensors, etc.), or ii) one or more signals received from other appliances, or both. Smart appliance 101 is described in more detail below and in FIG. 4.

As depicted, there are six smart appliances in system 100 (i.e., M=6). As those who are skilled in the art will appreciate after reading this specification, however, system 100 can comprise any number of smart appliances.

The smart appliances depicted in FIG. 1 are home appliances, which are electronic/electrical/mechanical machines that accomplish some household functions, such as cooking or cleaning. Such appliances can be classified into the categories of major appliances, small appliances, and consumer electronics, for example and without limitation. One or more of the “appliances” depicted might actually be fast-moving consumer goods (FMCG) dispensers, as explained below. Another “appliance” might comprise a container or other means for storage.

In some embodiments of the present invention, each smart appliance 101 can be configured to perform one or both of i) sensing and advertising one or more needs of the appliance and/or within its environment, and ii) detecting and acting upon one or more needs of other appliances.

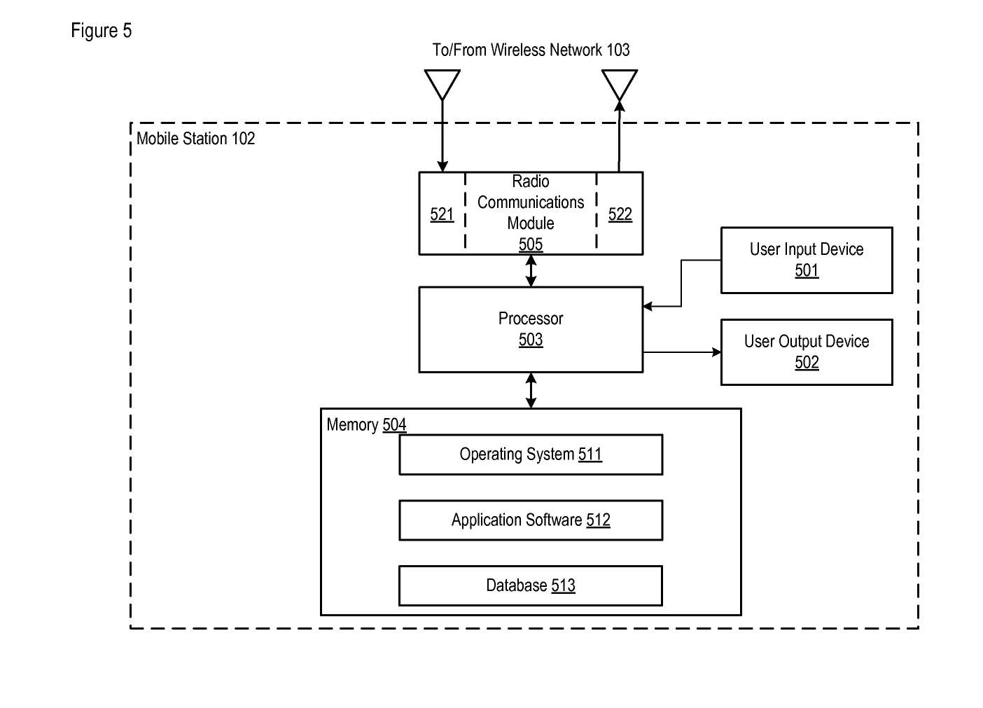

Mobile station 102 is a wireless telecommunications terminal that is configured to transmit and/or receive communications wirelessly. It is an apparatus that comprises memory, processing components, and communication components. Mobile station 102 comprises the hardware and software necessary to be compliant with the protocol standards used in the wireless network in which it operates and to perform the processes described below and in the accompanying figures. Mobile station 102 is described in detail below and in FIG. 5.

Furthermore, mobile station 102 is illustratively a smartphone with at least packet data capability provided and supported by the network in which it operates and that is configured to execute a software application (i.e., an “app”) for controlling and/or configuring one or more of the other devices depicted in FIG. 1. In some alternative embodiments of the present invention, mobile station 102 can be referred to by a variety of alternative names such as a wireless transmit/receive unit (WTRU), a user equipment (UE), a wireless terminal, cell phone, or a fixed or mobile subscriber unit, or can be any other type of computing device that is capable of operating in a wireless network environment, mobility-oriented or otherwise. For example and without limitation, mobile station 102 can be a tablet, a phablet, a notebook computer, a wall-mounted device, and so on.

As depicted, there is a single mobile station 102 in system 100. As those who are skilled in the art will appreciate after reading this specification, however, system 100 can comprise any number of mobile stations.

Wireless network 103 comprises a wireless personal area network (WPAN) that provides the elements of system 103 with connectivity to one other. In accordance with the illustrative embodiment of the present invention, network 103 comprises a communications medium for transmitting packets of data in accordance with the Bluetooth Low Energy (BLE) protocol. In some other embodiments of the present invention, telecommunications network 103 is another type of WPAN (e.g., Z-Wave, ZigBee, Wi-Fi, classic Bluetooth, etc.). In still some other embodiments, in which some or all of the appliances are in separate buildings or rooms, for example, network 103 might comprise the Internet. As those with ordinary skill in the art will appreciate after reading this disclosure, in some embodiments of the present invention network 103 can comprise one or more of the above-mentioned networks and/or other telecommunications networks, without limitation. Furthermore, as those with ordinary skill in the art will appreciate after reading this disclosure, telecommunications network 103 can comprise elements that are capable of wired and/or wireless communication, without limitation.

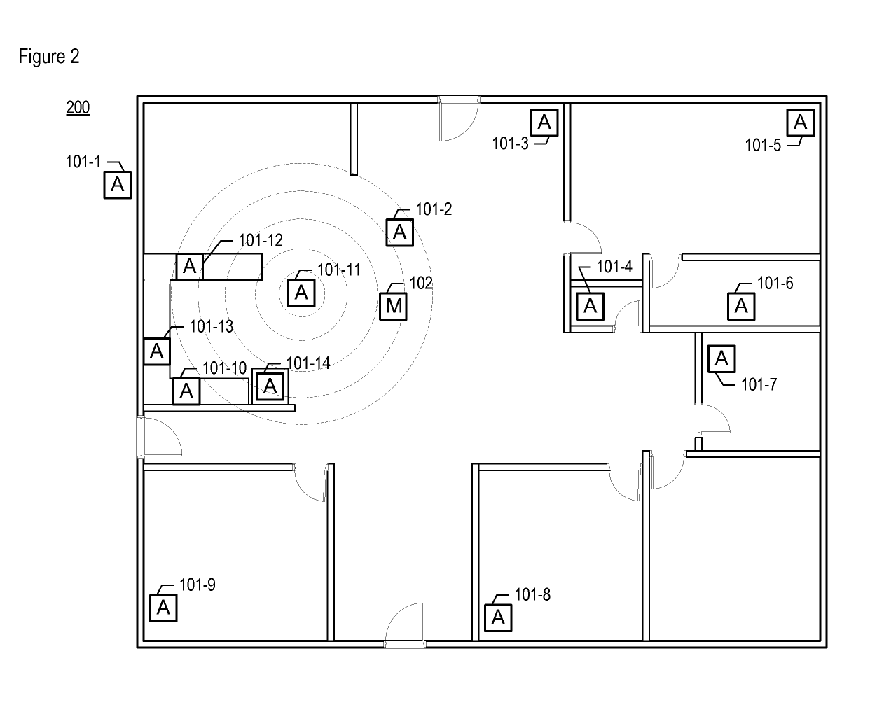

FIG. 2 depicts an illustrative floor plan of building environment 200, which comprises a building and a surrounding environment of the building. Building environment 200 is equipped with smart appliances 101-1 through 101-14 (i.e., labeled with an “A”) and also contains mobile station 102 (i.e., labeled with an “M”). The environment surrounding the building might include a strip of land running adjacent to the building, a yard or other property within which the building is situated, a street, a municipal area, and so on—for example and without limitation.

As those who are skilled in the art will appreciate, after reading this specification, environment 200 can comprise a different number of smart appliances than depicted. Furthermore, the building of environment 200 that is depicted is a house, but as those who are skilled in the art will appreciate, after reading this specification, the building can be a different type of structure with a roof and walls, or can instead be a defined area that comprises multiple sub-areas, wherein at least a portion of the area and/or sub-areas is defined by something other than a roof and/or walls.

At least some of the rooms or areas within the building comprise one or more smart appliances. The smart appliances provide at least some of the functionality described earlier. As can be seen in FIG. 2, smart appliances 101-1 through 101-14 are situated throughout the building and the surrounding environment. Although some of the appliances are generally stationary (e.g., coffeemaker, etc.) or are fixed in position (e.g., built-in dishwasher, etc.), at least some of the appliances can be customarily moved, either while in use (e.g., a toothbrush being picked up and handled, etc.) or for use at an entirely different location within environment 200 (e.g., flashlight being taken outside at night, etc.).

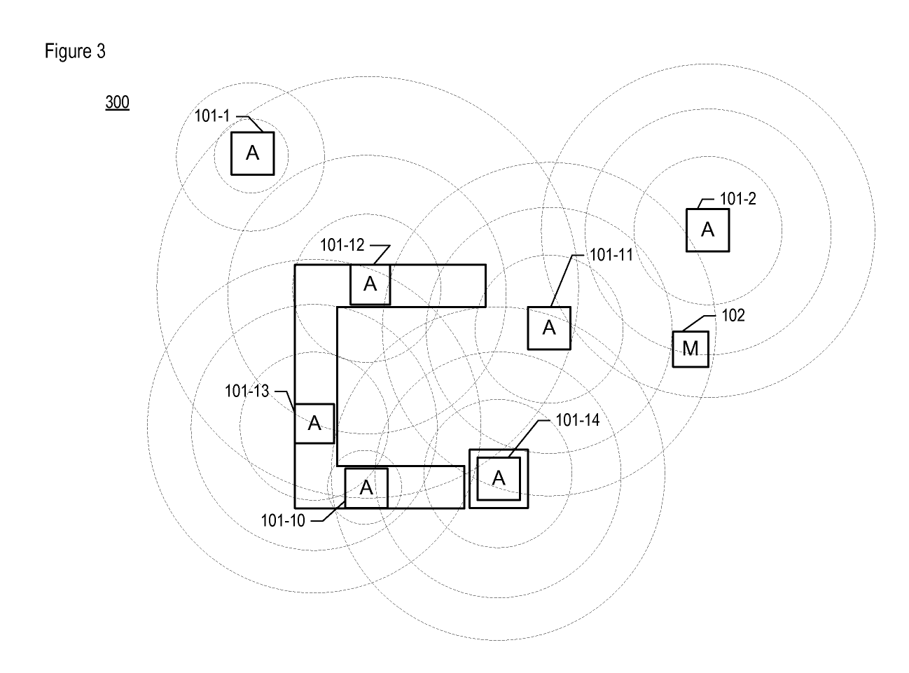

At least some of smart appliances 101-1 through 101-14 transmit a signal, as indicated by the concentric circles emanating from appliance 101-11, for example. FIG. 3 depicts a zoomed-in view of vicinity 300 around the kitchen area (with countertops and appliances illustrated, but no walls). Each of depicted smart appliances 101-1, 101-2, and 101-10 through 101-14 broadcasts a signal, but does not necessarily know who the recipient of the signal is. Each of the smart appliances might be transmitting it signals at a different signal-strength level, as indicated by the different numbers of circles around at least some of the appliances. Depending on various factors (e.g., transmitted strength, RF conditions, etc.), each smart appliance that is capable of listening might receive the transmitted signals at different received signal-strength levels, or might not, in fact, receive any signal from one or more of the other appliances.

Each smart appliance that is monitoring for signals that are being broadcast by other appliances can be programmed to listen to specific events from specific broadcasting appliances, as identified by their device addresses. Much of the control logic is in the smart appliances that are capable of listening to advertised needs and other information and of addressing (e.g., fulfilling, etc.) those needs, in contrast to smart appliances that are mainly capable of advertising their needs.

FIG. 4 depicts the salient components of smart appliance 101-m according to the illustrative embodiment of the present invention. According to the illustrative embodiment, smart appliance 101-m is based on a data-processing apparatus whose hardware platform comprises the following electronic components: sensor components 401-1 through 401-J, wherein J is a non-negative integer; actor components 402-1 through 402-K, wherein K is a non-negative integer; processor 403, memory 404, and home area network (HAN) interface module 405, interconnected as shown. In various configurations, there are i) both sensor and actor components present, ii) no sensor components but at least one actor component present, iii) at least one sensor component but no actor components present, and iv) neither sensor nor actor components present. Furthermore, in some embodiments of the present invention, one or more of the elements described below can be physically integrated with each other. For example and without limitation, in some embodiments, module 405 might provide some or all of the functionalities of processor 403 and/or memory 404.

Sensor component 401-j, wherein j has a value between 1 and J, inclusive, is an apparatus that comprises memory, processing components, and communication components, and is configured to transmit signals providing sensor-related information, as described in detail below. In accordance with the illustrative embodiment, each sensor component 401-j comprises a sensor, wherein the sensor gathers information about the environment that is accessible by the sensor. Each sensor component can be used to determine whether something at the appliance or in the appliance's environment is needed or will be needed at a certain point in time.

Each sensor is configured to monitor a particular physical condition in well-known fashion. A sensor senses a change in the condition being monitored and is configured to report a state of the condition by providing input signals to processor 403, wherein the values of the input signals are representative of the states being reported. A given sensor component 401-j can report discrete input signal values and/or a continuum of states and can report states at particular times and/or continuously. For example and without limitation, sensor component 401-j can comprise one or more of the following sensor with respective functions:
i. a motion detection sensor (e.g., a Passive InfraRed [PIR] element, etc.) to detect and report the motion and/or presence of humans. For example, the reported state might be “motion detected” or “motion not detected”.
ii. a temperature sensor to detect and report ambient temperature. For example, the reported state might be a temperature value.
iii. a light (luminescence) sensor to detect and report light level (e.g., ambient level, etc.). For example, the reported state might be a light-level value.
iv. a touch sensor to wake up and/or trigger other sensors, particularly those with a higher power draw (e.g., accelerometer, gyroscope, etc.). This sensor can report a touch event to trigger various actions when touched. This sensor can also be used as a protection against theft of a sensor component; for example, the system may sound an alarm when sensor component 301-j is touched or moved. For example, the reported state might be “contact detected” or “contact not detected”.
v. an accelerometer (e.g., single-axis, multi-axis, etc.) sensor to detect and report position/orientation (e.g., incline, etc.) and other motion-related events (e.g., taps, bumps, etc.). For example, the reported state might be an orientational value and/or a positional value.
vi. a gyroscope (e.g., single-axis, multi-axis, etc.) to detect and report motion (e.g., shifts, turns, etc.). For example, the reported state might be a translational motion value and/or a rotational motion value.
vii. an air humidity sensor to detect and report humidity level, for the purpose of controlling A/C, fans, and so on. For example, the reported state might be a humidity value.
viii. a carbon dioxide sensor to detect and report carbon dioxide level, for the purpose of controlling A/C, ventilation, and so on. For example, the reported state might be a carbon dioxide level value.
ix. a carbon monoxide sensor to detect and report carbon monoxide level, for the purpose of providing a security/safety alarm function. For example, the reported state might be a carbon monoxide level value.
x. a (natural) gas sensor to detect and report gas, for the purpose of providing a security/safety alarm function. For example, the reported state might be a gas level value.
xi. a flood (water) sensor to detect and report the presence of water, implemented with exposed contact electrodes, for example. For example, the reported state might be “water detected” or “water not detected”.
xii. a rain sensor to detect and report whether it is raining outside. For example, the report state might be “raining” or “not raining”.
xiii. a radio beacon receiver. In some embodiments of the present invention, component 401-j can be moved around; accordingly, component 401-j is configured to be able to determine and report its location (e.g., relative location, absolute location, etc.) via receiving one or more radiolocation beacons. In some embodiments, the component can detect the proximity of other radio location beacon sources such as smart buttons, key fobs, mobile stations emitting beacon signals, and so on.
xiv. a real-time clock that can be used in conjunction with geolocation information to compute the position of the Sun, making component 401-j aware of the outside light level (e.g., day versus night, etc.), which the component can report on.
xv. an electronic compass. For example, the reported state might be a static “heading” of the sensor component.
xvi. a sensor that is worn or carried by a person (e.g., a Jawbone Up24™ bracelet, etc.), which detects and reports a condition of the person or of the person's immediate environment. An advantage of using such a sensor associated with a person is that can provide a more direct indication of a human-related activity occurring within a building than other sensors associated with the building. Moreover, a sensor associated with a particular person is able to monitor the pace of the particular individual.
xvii. a sensor configured to sense a predetermined movement (e.g., translational, rotational, etc.).
xviii. a virtual “sensor” such as, but not limited to, a web-based service that monitors and reports on one or more environmental conditions, including reports comprising predictions of the future states of one or more of the conditions being monitored. For example, a temperature “sensor” can be a weather-forecasting web service that provides a forecast of a future temperature, future air quality, future cloud cover, future precipitation, and so on.

In some embodiments, a sensor can be configured to sense a predetermined movement at the appliance, wherein the signal produced correlates with the movement having been sensed by the sensor. In some embodiments of the present invention, the movement correlates with a use of a consumable good by the appliance. The following are non-limiting examples of such uses that are correlatable to one or more movements and their respective consumables that are used, either directly or indirectly:
i. a brushing with a toothbrush tip,
ii. a dispensing of soap from a soap cartridge,
iii. a use of a safety razor's blade refill,
iv. an emission of an air freshener's fragrance refill,
v. a dispensing (e.g., a pump movement, etc.) of a spray dispenser's spray refill,
vi. a dispensing of a beverage from a beverage cartridge,
vii. a dispensing of a toilet tissue holder's tissue roll,
viii. a use of a flashlight's battery, and
ix. a pouring of liquid (e.g., water, etc.) from a pitcher having a filter.

In some other embodiments of the present invention, an appliance or individual sensor component that is part of an appliance can instead be a physical button that a consumer or other user can press. In this case, the signal produced correlates with the movement of the button being pressed. For example and without limitation, the button might be pressed by the user in order to indicate that a corresponding consumable good has been used and is needed presently.

As those who are skilled in the art will appreciate, after reading this disclosure, sensor component 401-j can provide a different function or functions than those described above, either to detect one or more needs and/or to serve a different purpose. Furthermore, smart appliance 101-m can comprise any combination of and any number of sensor components and sensor functions, possibly including none, some, or all of those listed above.

Actor component 402-k, wherein k is equal to 1 through K, inclusive, is an apparatus that comprises memory, processing components, and communication components, and is capable of doing something in the course of being affected by signals originating externally to the actor component, possibly from one or more of the other smart appliances 101, possibly from mobile station 102, and/or possibly from one or more sensor components within current appliance 101-m and processed by processor 403. For example and without limitation, actor component 402-k can perform at least part of one or more household functions. In accordance with the illustrative embodiment of the present invention, each actor component 402-k takes decisions that are based on signals from one or more sources and performs appropriate actions upon the actor's environment. Each actor component acts upon its environment in well-known fashion. In some embodiments, an actor component is or comprises an actuator, as is known in the art.

Actor component 402-k is configured to receive, transmit, process, and/or relay signals conveying data, as well as being configured to affect a condition, physical or otherwise, in its environment. For example and without limitation, the condition being affected can be:
i. lighting, which can be adjusted (e.g., turning on or off, changing color or mood, displaying a picture or pattern, etc.).
ii. sound, which can be adjusted (e.g., increasing or decreasing volume, changing playlist or mood, turning on/off, selecting signal source, etc.).
iii. room climate, which can be controlled (e.g., increasing or decreasing temperature, humidity, air fragrance, etc.).
iv. temperature of a local object or substance (e.g., cooking food, boiling liquid, etc.).
v. an alert, which can be generated (e.g., of an email, of an SMS message, etc.).
vi. monitoring by a camera, which can be panned or tilted.
vii. home entertainment/home cinema settings (e.g., selecting one or more of signal source, streaming application, multimedia to play, audio language, subtitles, chapter, play/pause/stop, rewind/fast forward, etc.).
viii. connected/smart TV features (e.g., selecting application to be launched, navigating through on-screen menus, etc.).
ix. virtual keyboard—navigation on virtual keyboard displayed by other device (e.g., TV, set-top box, etc.).
x. control of shades/window coverings.
xi. access control (e.g., unlocking/locking doors, opening/shutting doors, authorizing access to selected rooms or zones, etc.).

As those who are skilled in the art will appreciate, after reading this disclosure, actor component 402-k can provide or perform a different function, household or otherwise, than those described above. Furthermore, smart appliance 102-m can comprise any combination of and any number of actor components, possibly including none, some, or all of those corresponding to the affected conditions listed above.

As those who are skilled in the art will appreciate, after reading this disclosure, smart appliance 101-m comprising one or more actor functions can be in a variety of forms. For example and without limitation, such forms include a light bulb as part of a lighting system, a media player as part of an audio/video system, a heater as part of an environment control system, an outgoing-email server as part of a messaging system, an actor in a water sprinkler system, a robot or robotic arm, a pan/tilt camera, a switch, a motor, a servo mechanism, a kettle for boiling liquids, and so on. As described earlier, each appliance can be further equipped with one or more sensors that sense relevant conditions (e.g., the temperature of the liquid in the kettle, etc.).

Processor 403 is a processing device, such as a microprocessor that is well known in the art. Processor 403 is configured such that, when operating in conjunction with the other components of smart appliance 101-m, processor 403 executes software, processes data, and telecommunicates according to the operations described herein, in particular the operations and sub-operations that constitute method 600.

Memory 404 is non-transitory and non-volatile computer storage memory technology that is well known in the art (e.g., flash memory, etc.). Memory 404 is configured to store operating system 411, application software 412, and database 413. The operating system is a collection of software that manages, in well-known fashion, smart appliance 101-m's hardware resources and provides common services for computer programs, such as those that constitute the application software. The application software that is executed by processor 403 according to the illustrative embodiment enables smart appliance 101-m to perform the functions disclosed herein. Database 413 comprises information about each sensor component and about each actor component, and other information about smart appliance 102-m, such as but without being limited to a device address (or other identifier), one or more identified needs, one or more types of needs (e.g., maintenance-related, household-function-related, etc.), one or more statuses of needs (e.g., urgent, non-urgent, present, future, etc.). In addition, for those devices that are able to listen to other appliances, database 413 comprises information related to the characteristics of one or more other appliances, the needs of one or more other appliances, and the actions to be taken to accommodate one or more other appliances.

It will be clear to those having ordinary skill in the art how to make and use alternative embodiments that comprise more than one memory 404; or comprise subdivided segments of memory 404; or comprise a plurality of memory technologies that collectively store the operating system, application software, and database.

HAN interface module 405 comprises a network adapter that is configured to enable smart appliance 101-m to telecommunicate with other devices and systems, by receiving signals therefrom and/or transmitting signals thereto via radio receiver 421 and radio transmitter 422, respectively, via Bluetooth Low Energy (BLE) in accordance with the illustrative embodiment of the present invention. For example, network interface module 405 communicates with one or more other appliances 101 and/or mobile station 102. In some other embodiments of the present invention, HAN interface module 305 can communicate via one or more different types of wireless network technology standards, in addition to or instead of BLE, such as Z-Wave, ZigBee, Wi-Fi, Bluetooth Classic, or Thread, for example and without limitation. In a multiple protocol configuration, a first network adapter can support a first standard (e.g., BLE, etc.), a second network adapter can support a second standard (e.g., WiFi, etc.), and so on, for example and without limitation.

Module 405 is based on an LSR TiWi-uB1 BLE module according to the illustrative embodiment of the present invention. In some other embodiments of the present invention, module 405 can be based on another type of module. As those who are skilled in the art will appreciate after reading this specification, module 405 can comprise one or more of the elements that are depicted in FIG. 4 as being separate from module 405, such as processor 403 and/or memory 404.

In accordance with the illustrative embodiment, smart appliance 101-m uses HAN interface module 405 in order to telecommunicate wirelessly with external devices. It will be clear to those skilled in the art, however, after reading the present disclosure, how to make use and use various embodiments of the present invention in which smart appliance 101-m communicates via a different type of wireless network (e.g., personal area network, local area network, etc.), or via a wired protocol (e.g., X10, KNX, etc.) over physical media (e.g., cable, wire, etc.) with one or more external devices, either in addition to or instead of the wireless capability provided by module 405. In any event, it will be clear to those skilled in the art, after reading this specification, how to make and use HAN interface module 405.

In some embodiments, smart appliance 101-m comprises one or more holders and/or dispensers that can accommodate supplies used by the particular appliance, such as one or more food items, toiletries (e.g., shaving cream, toothpaste, etc.), beverages (e.g., individual beverage components, pre-made beverage, etc.), paper goods, descaling/cleaning kits, and is further capable of predicting and/or notifying the consumer when the supplies thereof will be exhausted.

Smart appliance 101-m, in some embodiments, is not an “appliance” as such, but is another type of smart object/product, such as fast-moving consumer goods (FMCG) dispensers, for example and without limitation. For example, the “appliance” might be a toothpaste dispenser or a soap dispenser. As another example, an automatic spray dispenser equipped with an inexpensive low-power Bluetooth Smart radio can be modified to count the number of sprays and thereby predict and/or notify the consumer and/or automatically re-order refills, as those who are skilled in the art will appreciate after reading this specification. As another example, the “appliance” might also comprise a storage area such as a pantry, cabinet, or cupboard that is monitored by one or more sensors.

In some embodiments of the present invention, smart appliance 101-m might not be a physically distinct device; instead, its functionality might be embodied in one or more other devices that provide something other than smart appliance functionality. Furthermore, a single smart appliance 101-m might provide a single user-related function (e.g., boil water, cook a meal, etc.) or it might provide multiple functions (e.g., boil water and cook a meal, etc.).

A “smart kettle” is now provided as a non-limiting example of a smart appliance. The smart kettle is equipped with a Bluetooth Low Energy (BLE) module and supported by an iPhone™/Android™/smartphone software application, or “app”, running on a user's mobile station 102. The app enables “action at a distance,” for example enabling its user to start the kettle without leaving the couch. Also, when it boils the water, the kettle transmits a need, in this case a need for the user to take action, which the smartphone detects. Through the app, the smartphone then notifies the user (e.g., alert tone, vibration, etc.) to remind the user that the water is ready to be used for hot tea or for preparing another hot beverage. In another scenario, a different smart appliance 101-m, such as a smart toaster, can detect the need and, as a result, perform an appropriate function.

The smart kettle, as a smart appliance, informs its user via the connected app about the need for descaling, for example. The app provides a button to order the descaling kit online. Even when no descaling is needed, the app can provide the user with the ability to obtain other kettle-related supplies such as tea, instant coffee, instant soups, and so on, for example and without limitation. In doing so, the appliance is able to “talk” to users (i.e, through the app) and help them with purchasing decisions. As other non-limiting examples, a smart toaster may suggest a new kind of bread to use, a smart multicooker may suggest different types of foods to prepare, and so on.

FIG. 5 depicts the salient components of mobile station 102 according to the illustrative embodiment of the present invention. Mobile station 102 is based on a data-processing apparatus whose hardware platform comprises: processor 503, memory 504, and radio communications module 505, interconnected as shown.

User input device 501 enables mobile station 102 to acquire input from its user. For example, input device 501 can comprise a keyboard.

User output device 502 enables mobile station 102 to present information to its user. For example, output device 502 can comprise a display.

Processor 503 is a processing device that is similar to processor 403. Processor 503 is configured such that, when operating in conjunction with the other components of mobile station 102, processor 503 executes software, processes data, and telecommunicates according to the operations described herein, in particular the operations and sub-operations that constitute method 900.

Memory 504 is non-transitory and non-volatile computer storage memory technology that is well known in the art (e.g., flash memory, etc.) and is similar to memory 404. Memory 504 is configured to store operating system 511, application software 512, and database 513. The operating system is a collection of software that manages, in well-known fashion, mobile station 102's hardware resources and provides common services for computer programs, such as those that constitute the application software. The application software that is executed by processor 503 according to the illustrative embodiment enables mobile station 102 to perform the functions disclosed herein. Database 513 comprises information related to configuring and interacting with one or more smart appliances, the characteristics of the one or more appliances, the needs of one or more appliances, and the actions to be taken to accommodate one or more appliances. Database 513 also maintains one or more shopping lists as described below.

Radio communications module 505 is configured to enable mobile station 102 to telecommunicate with other devices and systems, by receiving signals therefrom and/or transmitting signals thereto via receiver 521 and transmitter 522, respectively. For example, radio communications module 505 communicates with one or more of smart appliances 101. Radio communications module 505 communicates with the smart appliances via Bluetooth Low Energy (BLE) and communicates, for example, within a cellular network in accordance with a cellular protocol. In some other embodiments, radio communications module 505 communicates via one or more other radio telecommunications protocols.

Receiver 521 is a component that enables mobile station 102 to telecommunicate with other components and systems by receiving signals that convey information therefrom. It will be clear to those having ordinary skill in the art how to make and use alternative embodiments that comprise more than one receiver 521.

Transmitter 522 is a component that enables mobile station 102 to telecommunicate with other components and systems by transmitting signals that convey information thereto. It will be clear to those having ordinary skill in the art how to make and use alternative embodiments that comprise more than one transmitter 522.

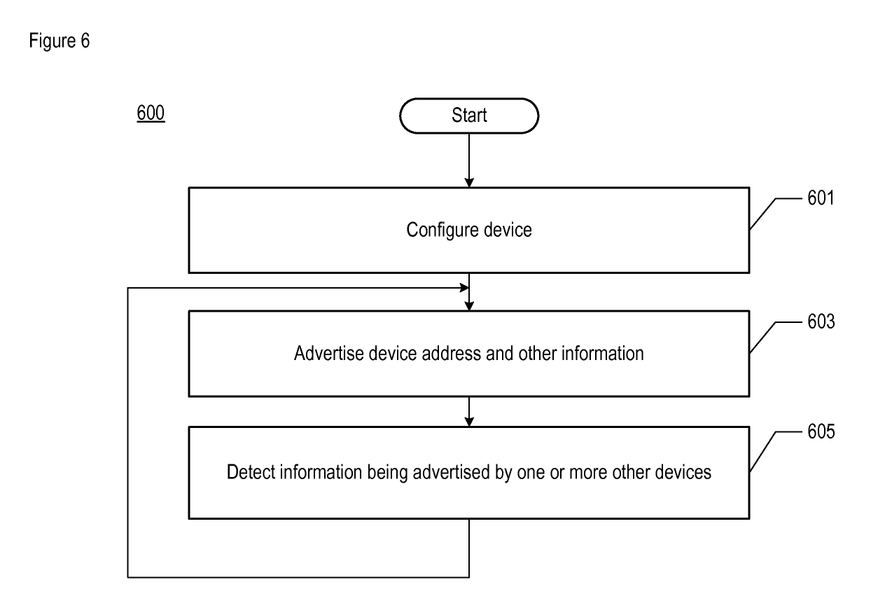

FIG. 6 depicts some salient operations of method 600 according to the illustrative embodiment of the present invention. Each smart appliance 101-m is the entity within illustrative system 100 that executes and coordinates at least some of the operations of method 600.

In regard to method 600 and other methods disclosed herein, it will be clear to those having ordinary skill in the art, after reading the present disclosure, how to make and use alternative embodiments of method 600 wherein the recited operations and sub-operations are differently sequenced, grouped, or sub-divided—all within the scope of the present invention. It will be further clear to those skilled in the art, after reading the present disclosure, how to make and use alternative embodiments of method 600 wherein some of the recited operations and sub-operations are optional, are omitted, or are executed by other elements and/or systems.

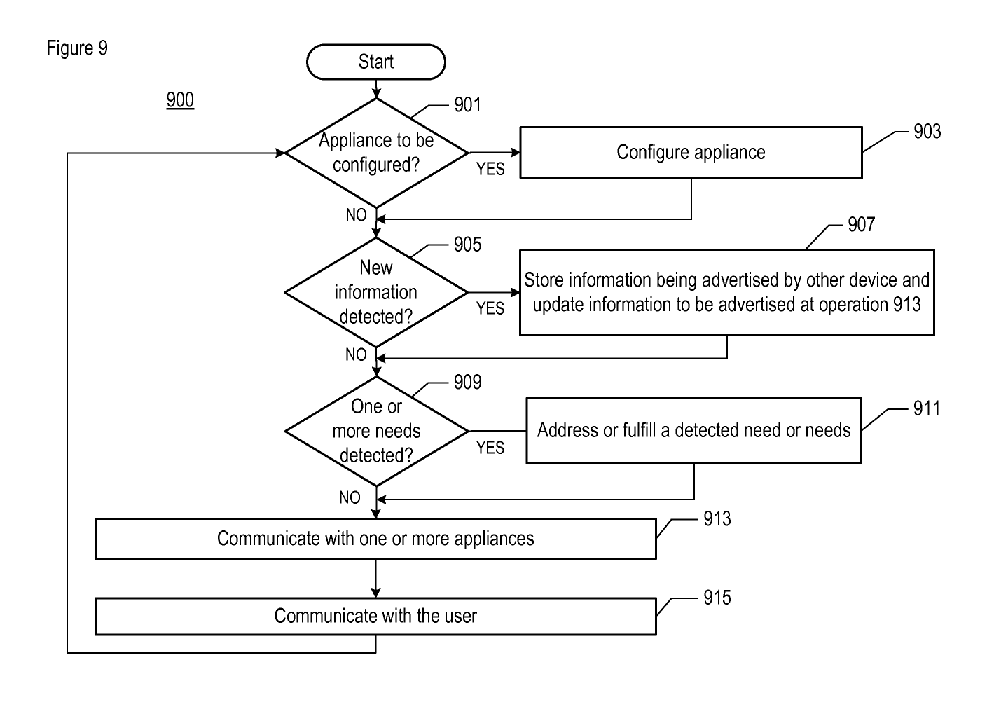

At operation 601, appliance 101-m interacts with mobile station 102 in order to be configured. The configuring process is described below and in FIG. 9.

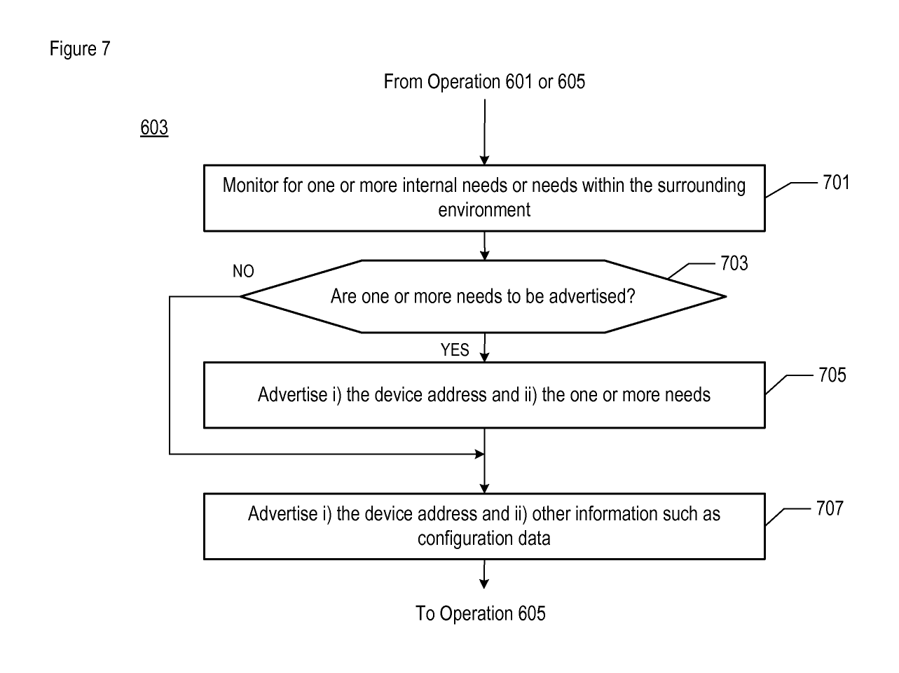

At operation 603, appliance 101-m advertises a variety of information, including its own device address and, possibly, one or more needs and/or information that describes the device itself. Operation 603 is described below and in FIG. 7.

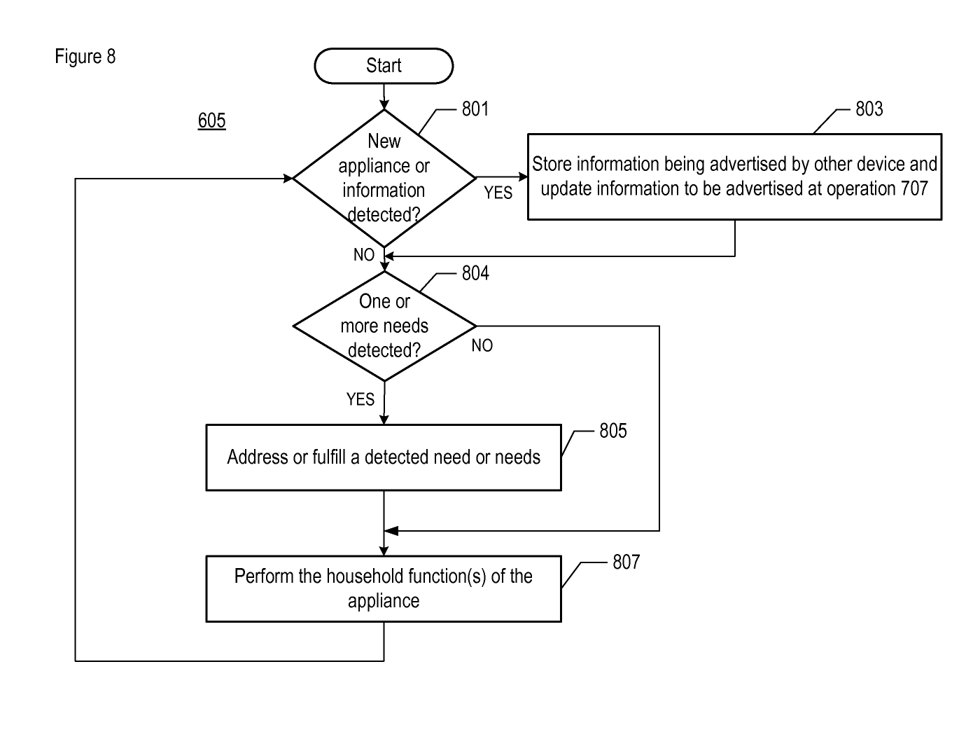

At operation 605, appliance 101-m detects and acts upon information being advertised by other devices. For example, the appliance might detect and address (e.g., fulfills, etc.) one or more needs as advertised by one or more other smart appliances. Operation 605 is described below and in FIG. 8. Subsequently, appliance 101-m can repeat operations 603 and/or 605 indefinitely or a specific number of times, as well as reconfigure when needed.

As those who are skilled in the art will appreciate after reading this specification, some appliances configured as reporting devices might execute operation 603 only, some appliances configured as listening devices might execute operation 605 only, and some appliances might be configured to execute both operations 603 and 605. Also, in some embodiments only a listening device can perform a household function while in some other embodiments any device can perform a household function.

FIG. 7 depicts some salient sub-operations within operation 603. At operation 701, appliance 101-m monitors for one or more needs. For example, processor 403 can receive signals from one or more of sensor components 401-1 through 401-J in order to directly determine from or to infer from the signals that one or more needs have arisen, are arising, or will arise. As those who are skilled in the art will appreciate after reading this specification, needs can be monitored for in other ways.

At operation 703, appliance 101-m determines whether one or more needs are to be advertised. In accordance with the illustrative embodiment of the present invention, a need can derive from the appliance's performance of its household function. Such needs can include a cooking ingredient, electrical power, a maintenance-related item (e.g., descaling kits, etc.), and so on. When the appliance itself cannot fulfill one or more of its own needs, the need can be advertised so that one or more other appliances can fulfill, or at least address, the need. If the need is to be advertised, control of execution proceeds to operation 705. Otherwise, control of execution proceeds to operation 707.

At operation 705, appliance 101-m advertises, or transmits, its device address and one or more of the needs that must be advertised as determined at operation 703. In some embodiments of the invention, the appliance advertises both its address and at least one need concurrently with each other (e.g., in the same message, within the same period of time, etc.).

In accordance with the illustrative embodiment of the present invention, appliance 101-m refrains from transmitting any device address other than its own, at least when advertising a need. In some alternative embodiments of the present invention, the appliance can transmit another device's address (e.g., that of a listening device, etc.) when advertising a need.

At operation 707, appliance 101-m advertises other information. For example and without limitation, a newly-configured (or reconfigured) appliance might advertise its address without also advertising a need, configuration information that other appliances might need to know (e.g., capacity, etc.), a description that includes its own capabilities including its household function (e.g., kettle for boiling water, etc.), maintenance-related information (e.g., when a kettle was last descaled, etc.), health status information, recommendations for use, and so on.

In some embodiments of the present invention, appliance 101-m can advertise information that describes the device itself, including at least some characteristics of the device. Each of the appliances can transmit its own characteristics, informing the environment around it about what it is and what it comprises. For example, a dual-channel wall switch might advertise that it is a device with two identical “on/off” characteristics. A characteristic, such as “name”, might be configured by a user during the setup process; for example, a user brings home a lamp from a store and names it “ceiling lamp”.

FIG. 8 depicts some salient sub-operations within operation 605. For pedagogical purposes, appliance 101-12, a smart kettle, is represented as being capable of listening to other smart appliances and as performing the operations that are now described. During execution of some or all of the operations, appliance 101-12 can refrain from transmitting any device address except its own.

As those who are skilled in the art will appreciate after reading this specification, at least some of the operations described below as being performed by one or more appliances might instead be performed by the smartphone app at mobile station 102.

At operation 801, appliance 101-12 checks whether another appliance has been detected as newly appearing in network 100. Appliance 101-12 do so by noting the transmitting device's address and determining whether it is already aware of the address or not, or at least determining whether the other appliance is advertising new information. If appliance 101-12 detects a new appliance and/or new information being advertised, control of execution passes to operation 803. Otherwise, control passes to operation 804.

At operation 803, appliance 101-12 stores information being transmitted by the detected appliance, in this case multicooker 101-10, and updates accordingly the information that it advertises in accordance with operation 707, which can in turn be subsequently detected by appliance 101-10 or any other appliance capable of listening. For example, appliance 101-12 might detect a description advertised by appliance 101-10, including appliance 101-10's household function and other data (e.g., when appliance 101-10 was last serviced, recommendations for the user, etc.). Appliance 101-12 might update for subsequent advertising a description that includes its own household function (e.g., kettle for boiling water) and other data (e.g., when kettle 101-12 was last descaled, recommendations to its user on different uses of the kettle, how it uses electrical power, etc.). In some embodiments, appliance 101-12 updates what it advertises based on the newly detected appliance 101-10.

Appliance 101-12 can also detect and store information that is being advertised by additional appliances. These appliances are detected by appliance 101-12 as being new to network 100 (from appliance 101-12's perspective) and/or pre-existing in network 100. For example, kettle 101-12 might detect that dishwasher 101-13 is also part of network 100, either because the dishwasher was recently installed or because kettle 101-12 itself is new to the network. Kettle 101-12 then proceeds to store information advertised by dishwasher 101-13, if needed, and updates the information that it advertises so that dishwasher 101-13, if a listening device, can obtain the kettle's information if needed.

Also, appliance 101-12 might store information from other smart systems within the home that are not appliances (or FMCG dispensers, as described earlier). For example, kettle 101-12 might detect that pantry 101-14 is present within network 100 and store information advertised by the pantry.

In some embodiments, appliance 101-12 might exchange information directly (i.e., point-to-point transmission) with one or more other devices, instead of or in addition to detecting information being transmitted by other devices and broadcasting information for any device to hear.

After appliance 101-12 stores the information from, or exchanges the information with, one or more other devices, appliance 101-12 modifies its recommendations (e.g., for shopping, for food preparation, etc.) accordingly, based on now knowing i) that one or more additional appliances are present, ii) the description of each of the one or more additional appliances, and/or iii) the recommendations related to the one or more additional appliances.

At operation 804, appliance 101-12 checks whether a need is being advertised by another appliance. If appliance 101-12 detects a need being advertised, control of execution passes to operation 805. Otherwise, control passes to operation 807.

At operation 805, appliance 101-12 addresses a need of one or more other appliances (e.g., by ordering a cooking ingredient, by modifying its own use of electrical power, etc.) as a result of detecting, at operation 804, one or more needs being advertised by the other appliance at operation 705. In some embodiments, a need is addressed by going as far as actually fulfilling the need. In fulfilling a need, the need might be completely fulfilled or partially fulfilled. In some cases, appliance 101-12 addresses the need that is actually being advertised by a second appliance, while in some other cases, the appliance addresses a second need of the second appliance based on detecting the advertised need, while in still some other cases, the appliance addresses a need of a third appliance based on detecting a need advertised by the second appliance.

Appliance 101-12 responds to the detection of a need or addresses the need based on the value of the advertising device's address, which can be checked against the one or more addresses stored in database 413. In some embodiments, appliance 101-12 responds to the detection of a need or addresses the need based on one or more characteristics that are advertised by the advertising device.

In some embodiments, appliance 101-12 responds to the detection of a need or addresses the need by foregoing, at least temporarily (e.g., for a predetermined amount of time, etc.) its own fulfillment of one of its own needs (e.g., a need that is substantially similar to the advertised need, etc.). For example, a need in common among the appliances might be electrical power, and appliance 101-12 responds by suspending or limiting its own usage of electricity. This can also be based on appliance 101-12 having received and stored, at operation 803, a profile of how electrical power is used by the other household appliance, in relation to how appliance 101-12 uses power. In addition to addressing energy conservation, electricity management can be useful, for instance, when two or more appliances are on the same electrical circuit in a building; the maximum amount of electrical current on the circuit can be managed by appliance 101-12 in order to avoid tripping the circuit breaker dedicated to that circuit.

Appliance 101-12, in some embodiments, responds to the detection of a need or addresses the need of a second appliance by accounting for the needs of and/or information provided by one or more appliances other than, or in addition to, the second appliance. For example and without limitation, appliance 101-12 might detect a need of a descaling kit from one appliance but might adjust the ordering of a new kit based similar needs of one or more other appliances, as described in a scenario below.

In some embodiments, appliance 101-12 responds to the detection of a need or addresses the need by advertising an offer that is based on one or more of the needs being advertised. The advertising of an offer might result in a response from one or more other appliances, either through those appliances broadcasting a response to the appliances at large or by directly responding to appliance 101-12.

Fulfillment of a particular need can be determined by noting at some point that the appliance-in-need no longer advertises that need (i.e., appliance 101-12 no longer detects the need that was being advertised). Fulfillment of a need can also be defined in terms of a particular action being taken in response to a particular need (e.g., ordering of an item from a supplier in response to the item being needed, etc.). As those who are skilled in the art will appreciate after reading this specification, other ways of determining whether a need is being fulfilled are possible.

At operation 807, appliance 101-12 performs at least part of its household function or functions, depending on whether its user requires the household function to be performed at that moment and whether the appliance, in fact, has a household function to perform. A household function can include the following, for example and without limitation: heating, cooling, humidifying, refrigerating, freezing, purifying, cooking, toasting, opening containers, processing food, blending, dispensing, boiling, brewing, descaling, cleaning, disinfecting, washing, drying, storing, sealing, performing of some combination of actor functions described above and in FIG. 4, and so on. In some embodiments, the household function might be performed in the background, thereby enabling the appliance to continue to perform its other operations. Notably, one or more needs might derive from the performing of these functions, and appliance 101-12 might at some point advertise this need or needs.

In some embodiments of the present invention, when performing its household function, appliance 101-12 takes into account the information that is exchanged with one or more other appliances or systems at operation 803. For example, if it is prone to scale build-up, but it knows that wireless network 100 is aware that a descaling kit is ready and available, the appliance might operate in its conventional way; however, if it knows that a descaling kit needs to be ordered, the appliance might operate in a way that minimizes additional scale build-up or change in a different way how it operates, especially if the appliance knows that other appliances are in need of a descaling kit as well. Similarly, other household functions can be modified based on how acute a need is or how soon the need will be met.

In some embodiments of the present invention, appliance 101-12 updates its operational data, supply data, and other data, taking into account the additional use of the appliance at operation 807, if any. For example and without limitation, kettle 101-12 (or any other type of appliance) might update i) when it was used, ii) for how long, iii) its frequency/pattern of use, iv) any sensed wear-and-tear or aging (e.g., scale build-up, etc.), and so on.

Control of execution then proceeds back to operation 801.

FIG. 9 some salient operations of method 900 according to the illustrative embodiment of the present invention. Through its smartphone app, mobile station 102 is the entity within illustrative system 100 that executes and coordinates at least some of the operations of method 900. As those who are skilled in the art will appreciate, after reading this specification, at least some of the operations described below and performed by mobile station 102 through execution of its smartphone app might instead be performed one or more of the smart appliances.

At operation 901, mobile station 102 checks whether an appliance 101-m needs to be configured, such as when the appliance is powered on for the first time and as part of an initialization procedure. If mobile station 102 detects a new appliance in need of being configured, control of execution passes to operation 903. Otherwise, control passes to operation 905.

At operation 903, mobile station 102 configures appliance 101-m by exchanging information with it, in part information specified by a user through the smartphone application. Operation 903 corresponds to operation 601 performed by the smart appliance. In some embodiments of the present invention, mobile station 102 can configure appliance 101-m to advertise information that describes the device itself, including at least some characteristics of the device, as described above and in operation 707.

At operation 905, mobile station 102 checks whether an appliance is advertising new or updated information. If mobile station 102 detects new or updated information, control of execution passes to operation 907. Otherwise, control passes to operation 909.

At operation 907, mobile station 102 stores new or updated information being transmitted by an appliance, illustratively multcooker 101-10, and updates accordingly any information that mobile station 102 advertises in accordance with operation 913, which can in turn be subsequently detected by appliance 101-10 or any other appliance capable of listening. For example, mobile station 102 might detect a description advertised by appliance 101-10, including appliance 101-10's household function (e.g., multicooker) and other data (e.g., maintenance history, cooking recommendations for the user, etc.). Mobile station 102 might update for subsequent advertising information that includes information that might be relevant to multicooker 101-10 (e.g., information externally obtained off the Internet, etc.) or relevant to other devices about multicooker 101-10.

Also, mobile station 102 might store information from other appliances and/or from smart systems within the home that are not appliances (or FMCG dispensers, as described earlier). For example, mobile station 102 might detect that pantry 101-14 is present within network 100 and store information advertised by the pantry.

In some embodiments, mobile station 102 might exchange information directly (i.e., point-to-point transmission) with one or more other devices, instead of or in addition to detecting information being transmitted by other devices and broadcasting information for any device to hear.

After mobile station 102 stores the information from, or exchanges the information with, one or more other devices, mobile station 102 modifies its recommendations (e.g., for shopping, for food preparation, etc.) accordingly, based on now knowing i) that one or more additional appliances are present, ii) the description of each of the one or more additional appliances, and/or iii) the recommendations related to the one or more additional appliances.

At operation 909, mobile station 102 checks whether an appliance is advertising a need. If mobile station 102 detects a need being advertised, control of execution passes to operation 911. Otherwise, control passes to operation 913.

At operation 911, mobile station 102 addresses a need of one or more other appliances as a result of detecting, at operation 909, one or more needs being advertised by the appliance at operation 705. In some embodiments, a need is addressed by going as far as actually fulfilling the need. In fulfilling a need, the need might be completely fulfilled or partially fulfilled. In some cases, mobile station 102 addresses the need that is actually being advertised by a first smart appliance, while in some other cases, the mobile addresses a second need of the first appliance based on detecting the advertised need, while in still some other cases, the mobile addresses a need of a second appliance based on detecting a need advertised by the first appliance.

Mobile station 102 responds to the detection of a need or addresses the need based on the value of the advertising device's address, which can be checked against the one or more addresses stored in database 513.

Mobile station 102, in some embodiments, responds to the detection of a need or addresses the need of a first appliance by accounting for the needs of and/or information provided by one or more appliances or systems other than, or in addition to, the first appliance. For example and without limitation, mobile station 102 might aggregate a shopping list of needs from one or more appliances, might de-duplicate one or more needs that two are more appliances have in common, might create multiple shopping lists of needs based on one or more criteria that are need-related or supplied-related, and so on.

In some embodiments, individual shopping lists are maintained in the app (e.g., one per appliance, etc.), while in some other embodiments, shopping lists are consolidated, either by the app itself or by the appliances. An appliance might have an effect on the contents of a single shopping list, of multiple shopping lists, or no shopping lists. Different appliances might affect different shopping lists in different ways.

Mobile station 102 can fulfill the need in any of a number of ways. For example and without limitation, station 102 can use social networking to determine whether human neighbors or acquaintances may provide an item in need (e.g., a cup of sugar, etc.). As another example, station 102 can monitor long-term usage of one or more items across one or more appliances; based on having this broader view, the mobile station 102 can make recommendations, to one or more of its user and/or one or more appliances. Mobile station 102 can proactively order one or more items in need from a supplier or can consult with its human user first.

Mobile station 102 is also capable of i) monitoring, through its sensors and one or more apps, or ii) accepting as input from user input device 501, its own human user's needs. For example and without limitation, mobile station 102 can determine whether the user is comfortable or not, the health status of the user, the diurnal status of the user, and so on; based on these findings, the mobile station can update, and treat in general, its record of its human user's needs, as if they were needs and information of one or more appliances.

In some embodiments, mobile station 102 responds to the detection of a need or addresses the need by advertising an offer that is based on one or more of the needs being advertised. The advertising of an offer might result in a response from one or more appliances, either through those appliances broadcasting a response to the appliances at large or by directly responding to mobile station 102.

At operation 913, mobile station 102 communicates with one or more other appliances and systems, based on the results of one or both of operations 907 and 911.

At operation 915, mobile station 102 communicates with the user, via the smartphone application, based on the results of one or both of operations 907 and 911. The smartphone app can present one or more shopping lists to its user via user output device 502, wherein one or more of the appliances have populated the shopping lists and mobile station, as described above. In some embodiments, a given shopping list is updated over time, based on one or more of the operations depicted in FIG. 9.

Control of execution then proceeds back to operation 901.

Some examples are now provided, in which each appliance 101-m performs the operations of method 600, configuring and then continually advertising its own information and detecting information advertised by other devices. Mobile station 102 interacts with one or more of the smart appliances by performing the operations of method 900.

### First Example

Smart device 101-12, a kettle, interacts with one or more other smart devices, namely dishwasher 101-13 and pantry 101-14.

Via operation 603, kettle 101-12 assessed its own needs and consequently advertises that it is going order a descaling kit. Via operation 605, dishwasher 101-13 detects the advertised need, detects its own need for a descaling kit, and consequently advertises that need via operation 603.

In a turn of events, pantry 101-14 detects via operation 605 what has been advertised so far and checks its supplies, and via operation 603 consequently advertises that one unused descaling kit is still available. Lastly, kettle 101-12 advertises in response and via operation 603 that it will order a single descaling kit total. Kettle 101-12 might then communicate the order to mobile station 102, either directly (point-to-point) or via broadcasting. For example and without limitation, upon resolving which and how many supplies to buy, kettle 101-12 might communicate to the smart phone app that recommends to the user that the descaling kit be ordered at this time. Alternatively, kettle 101-12 might instead proactively order the descaling kit and update the user after the fact.

Notably, in addition to resolving the supplies to order, as part of a coordinated shopping event, kettle 101-12 (and the other appliances involved) also learns updated information about each of the other appliances, as discussed earlier and in regard to operation 803, among other places.

Instead of automatically determining the type and quantity of supplies/ingredients to order, one or more of the appliances can merely keep track of each appliance's own needs and/or suggestions, or the collective needs and/or suggestions of the appliances, with the idea of eventually presenting the information to the user (via the smartphone app) in order to have the user make the ordering decision.

The smartphone app executing at mobile station 102 can present a shopping list to its user, wherein one or more of the appliances have advertised their needs and thereby contributed to the shopping list, with or without actual decisions having been made by the appliances. A given shopping list can be updated over time, based on one or more of the operations depicted in FIG. 9 performed by mobile station 102. In some embodiments, a given shopping list is updated over time, based on one or more of the operations depicted in FIG. 8 and by one or more of the appliances.

In some embodiments, individual shopping lists are maintained in the app (e.g., one per appliance, etc.), while in some other embodiments, shopping lists are consolidated, either by the app itself or by the appliances. An appliance might have an effect on the contents of a single shopping list, of multiple shopping lists, or no shopping lists. Different appliances might affect different shopping lists in different ways.

### Second Example

Multicooker 101-10 and a food processor 101-11 interact. First, cooker 101-10 and processor 101-11 individually advertise information via operation 603. This information might include a description of the appliance, including its household function (e.g., multicooker, food processor, etc.) and other data (e.g., when the cooker was last serviced, when the blades of the processor were last sharpened/replaced, etc.).

Additionally, cooker 101-10 and/or processor 101-11 each might advertise one or more food preparation recipes. Notably, without any exchange of information with processor 101-11, cooker 101-10 could have previously acquired (e.g., at the factory, by accessing the Internet, etc.) a first set of recipes (as a default or otherwise) that are relevant to cooking food with a multicooker. But once cooker 101-10 detects and becomes aware of the information advertised by processor 101-11, cooker 101-10 now knows that a food processor is available and/or obtains-and-stores recipes from processor 101-11 that are specific to food preparation involving a food processor. Based on knowing that the user has access to a food processor (in addition to having a multicooker), cooker 101-10 is able to suggest/recommend a set of recipes to the user (e.g., via the smartphone app).

In some scenarios, cooker 101-10 and processor 101-11 can each adjust how its performs one or more of their household functions based on knowing that the other appliance is present and being used. In one non-limiting scenario, cooker 101-10 might adjust its cooking time and/or temperature knowing that the cooking preparation process is being assisted by food processor 101-11. In another non-limiting scenario, the cooker and/or food processor can decide on what to order in terms of cooking ingredients (or other appliances or utensils) that are necessary for cooking one or more recipes suggested or recommended to the user. The interaction between the two appliances (and maybe others) can be similar to the interaction occurring between the other appliances (i.e., kettle, dishwasher, and pantry) described in the first example.

In terms of a shopping list that the smartphone app presents to its user, multicooker 101-10 might be responsible for providing the list of items to the app. The list might consist of only those items recommended by the cooker (in the absence of food processor 101-11) or the list might consist of items that take into account the presence of both the cooker and processor. Alternatively, food processor 101-11 might be responsible for providing the list of items to the app. The list might consist of only those items recommended by the processor (in the absence of cooker 101-10) or the list might consist of items that take into account the presence of both the cooker and processor. A list that accounts for the presence of both the cooker and processor might consist of items recommended by the cooker and processor individually, or it might consist only of items recommended for when the cooker and processor are both available.

As with the first example above concerning the kettle, dishwasher and pantry, the smartphone app executing at mobile station 102 can present a shopping list to its user, wherein one or more of the appliances have advertised their needs and thereby contributed to the shopping list, with or without actual decisions having been made by the appliances.

As those who are skilled in the art will appreciate, after reading this specification, the examples provided above can be applied to different smart appliances and/or FMCG dispensers than those illustrated, different types of supplies/ingredients to be ordered than those illustrated, different types of recommendations to be made than those illustrated, and so on, without limitation.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A home automation and control system comprising:
a first device, wherein the first device is capable of identifying itself with a first address, and is configured to advertise wirelessly the first address and a first need concurrently with each other, wherein the first device is incapable by itself of fulfilling the first need; and
a second device, wherein the second device is capable of identifying itself with a second address, and is configured to:
i) detect information advertised by devices besides the second device, and
ii) respond to detection of the first need as advertised by the first device such that the first need is at least partially fulfilled;
wherein the first device is configured to refrain from transmitting, in conjunction with advertising the first need, any address except for the first address; and
wherein the second device is configured to refrain from transmitting, in conjunction with responding to the detection of the first need, any address except for the second address.

2. The system of claim 1 wherein the first device and the second device are configured to refrain from transmitting, in conjunction with responding to any device, any address except for the first address and second address, respectively.

3. The system of claim 1 wherein the second device is configured to respond to detection of the first need as advertised by the first device based on the value of the advertised first address.

4. The system of claim 1 wherein the second device has a need that is substantially similar to the first need as advertised by first device, and wherein the second device is configured to respond to the detection of the first need by foregoing temporarily its own fulfillment of the substantially similar need.

5. The system of claim 4 wherein the substantially similar need is electrical power, and wherein the second device is configured to respond to the detection of the first need by suspending temporarily its own usage of electricity.

6. The system of claim 5 wherein the second device is configured to suspend its own usage of electricity based on a profile of how electrical power is used by the first device in relation to a profile of how electrical power is used by the second device.

7. The system of claim 1 wherein the second device is configured to respond to the detection of the information, by advertising a need that is similar to the first need as advertised by the first device.

8. The system of claim 1 wherein the second device is configured to respond to the detection of the information, by advertising an offer that is based on the first need as advertised by the first device.

9. The system of claim 1 wherein the information advertised further includes identification of a cooking ingredient, at least in part, by the first device.

10. The system of claim 1 wherein the second device is further configured to iii) respond to detection of a third need as advertised by a third device such that the third need is at least partially fulfilled.

11. The system of claim 10 wherein the second device is further configured to iv) advertise wirelessly the second address and a second need concurrently with each other;
wherein the second device responds to the detection of the third need based on at least one of the first and second need.

12. The system of claim 1 further comprising a third device configured to receive information from a human user and to advertise wirelessly a need of the human user;
wherein the third device is incapable by itself of fulfilling the need of the human user;
wherein the second device is further configured to respond to detection of the need of the human user such that the need of the human user is at least partially fulfilled.

13. A home automation and control system comprising:
a first device, wherein the first device is capable of identifying itself with a first address, and is configured to advertise wirelessly the first address and a first need and concurrently with each other, wherein the first device is incapable by itself of fulfilling the first need;
a second device, wherein the second device is capable of identifying itself with a second address, and is configured to advertise wirelessly the second address and a second need concurrently with each other, wherein the second device is incapable by itself of fulfilling the second need; and
a third device configured to:
i) detect information advertised by devices besides the third device,
ii) respond to detection of the first need as advertised by the first device without transmitting the first address, and
iii) respond to detection of the second need as advertised by the second device without transmitting the second address;
wherein the third device responds to the detections of the first and second need by displaying a datum that is based on the relationship of the first and second need to each other.

14. The system of claim 13 wherein the first device is configured to perform a first household function from which the first need derives and the second device is configured to perform a second household function from which the second need derives.

15. The system of claim 13 wherein the datum that is displayed represents a single instance of a need when the first need and second need are substantially similar to each other.

16. The system of claim 15 wherein the single instance represented is of a cooking ingredient.

17. The system of claim 15 wherein the single instance represented is of a maintenance-related item.

18. The system of claim 13 wherein the datum that is displayed is further based on a supplier of an item in need.

19. A home automation and control system comprising:
a first device, wherein the first device is capable of identifying itself with a first address, and is configured to advertise wirelessly the first address and a first need of a consumable concurrently with each other, wherein the first device is incapable by itself of fulfilling the first need; and
a second device, wherein the second device is capable of identifying itself with a second address, and is configured to:
i) detect information advertised by devices besides the second device, and
ii) respond to detection of the first need as advertised by the first device, based on a) the first need and b) the second device having a second need that is substantially similar to the first need as advertised by the first device; and
wherein the first device is configured to refrain from transmitting, in conjunction with advertising the first need, any address except for the first address.

20. The system of claim 19 wherein the first device is configured to perform a first household function from which the first need derives and the second device is configured to perform a second household function from which the second need derives.

21. The system of claim 19 wherein the consumable is a cooking ingredient.

22. The system of claim 19 wherein the consumable is a maintenance-related item.
